(19) United States
(12) Patent Application Publication
(10) Pub. No.: US 2018/0247085 A1
(43) Pub. Date: Aug. 30, 2018

(54) SECURE JOB POOL AND PROCESS

(71) Applicant: HEWLETT PACKARD ENTERPRISE DEVELOPMENT LP, Houston, TX (US)

(72) Inventors: Lee Preimesberger, Houston, TX (US); Jorge Cisneros, Houston, TX (US); Ying-Jie Wang, Taipei (TW)

(21) Appl. No.: 15/756,271

(22) PCT Filed: Oct. 30, 2015
(86) PCT No.: PCT/US15/58379

§ 371 Date: Feb. 28, 2018

(51) Int. Cl. G06F 21/79; G06F 21/71; G06F 21/81; G06F 9/54

(52) U.S. Cl. CPC G06F 21/79; G06F 9/54; G06F 21/81; G06F 21/71

(57) ABSTRACT

An example device includes processor and a secure storage area having accessibility limited to a secure communication. The secure storage area stores a job pool with at least one job to be processed. The processor is to process the at least one job from the job pool when the processor is running. The secure storage area is a private storage of a management controller of the device.

### BACKGROUND

Servers are regularly accessed by various client devices for various reasons. For example, a remote web client may access a server to obtain data or to perform execution of software provided on the server.

### BRIEF DESCRIPTION OF THE DRAWINGS

For a more complete understanding of various examples, reference is now made to the following description taken in connection with the accompanying drawings in which:

FIG. 1 illustrates an example device for securely queuing and processing a set of jobs;

FIG. 2 illustrates an example system including the example device of FIG. 1 for securely queuing and processing a set of jobs in the example device;

FIG. 3 illustrates an example device;

FIG. 4 is a schematic illustrating the queuing of a set of jobs in the example device of FIG. 3;

FIG. 5 is a flow chart illustrating an example process for operation of an example job pool;

FIG. 6 is a flow chart illustrating an example process for processing a set of jobs from the example job pool; and

FIG. 7 illustrates a block diagram of an example system with a computer-readable storage medium including instructions executable by a processor for queuing a set of jobs.

### DETAILED DESCRIPTION

Various examples described herein provide for secure queuing and processing of a set of jobs that may be received by a device (e.g., server device). A job pool may be provided in a secure storage area, which may be a private storage in an embedded management controller of the server device. The embedded management controller of the server device may be running and online both when the main processor of the server device is running and when the main processor is in an inactive mode. Further, the job pool may be such that its access by a remote device is limited to (e.g., can only be accessed using) a secure protocol, and may be further limited to a predetermined set of commands.

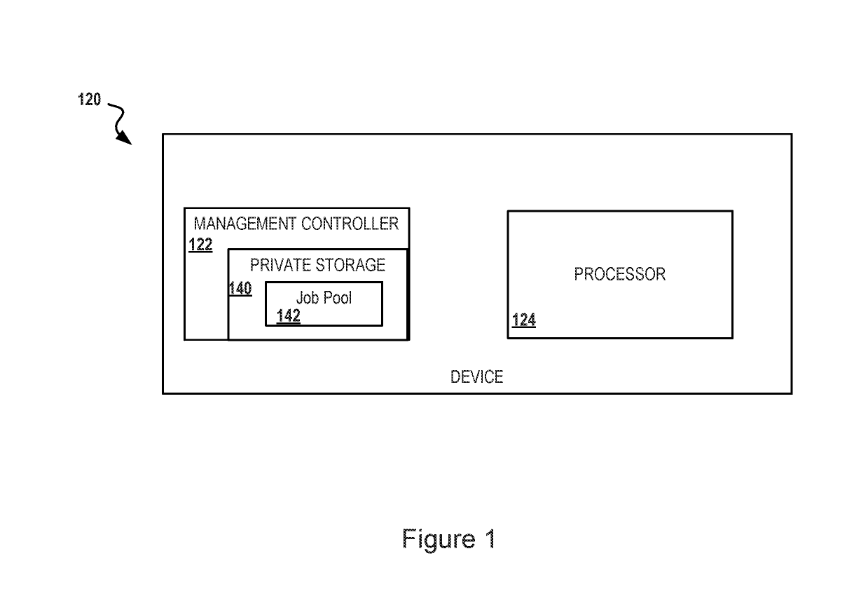

Referring now to the figures, FIG. 1 illustrates an example device for securely queuing and processing a set of jobs. For some examples, the example device 120 is a server or another suitable computing device. The example device 120 includes an embedded management controller 122 and a processor 124 (e.g., server processor). The processor 124 may be a central processing unit (CPU) for executing various instructions provided in software, firmware, etc. The processor 124 may operate according to an operating system.

The example management controller 122 performs functions to manage the device 120, such functions including those of a baseboard management controller (BMC). The example management controller 122 can be connected to a network using a communication port on the device 120, for example.

The example management controller 122 is provided with an internal, private storage 140 forming a secure storage area. The private storage 140 may be accessible by the operating system of the device 120 in a read-only or a read/write mode.

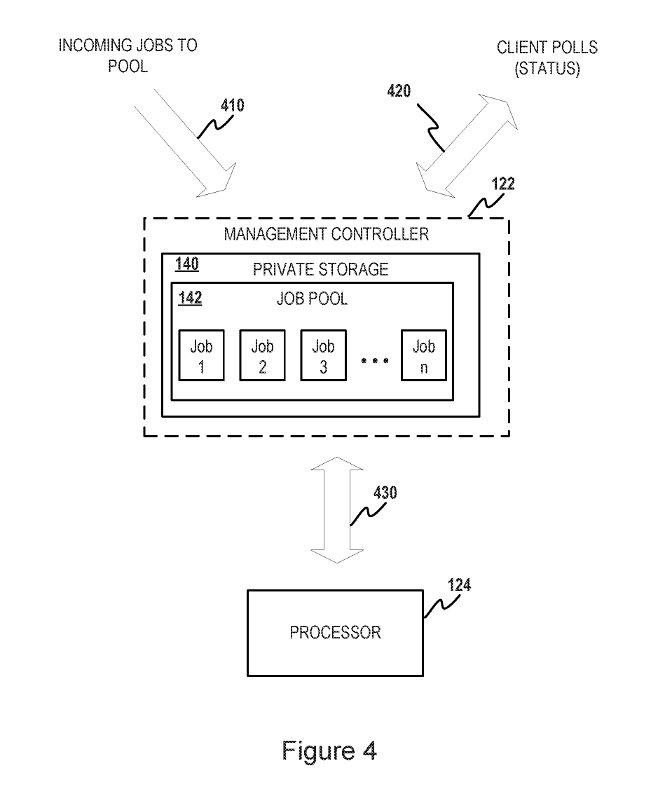

The example private storage 140 is provided with a job pool 142, which may comprise a job queue. As described in detail below with reference to FIG. 4, the job pool 142 may receive a set of jobs from various components, such as a remote client or an administration device. A job in the job pool 142 may be retrieved by the processor 124 for execution or processing.

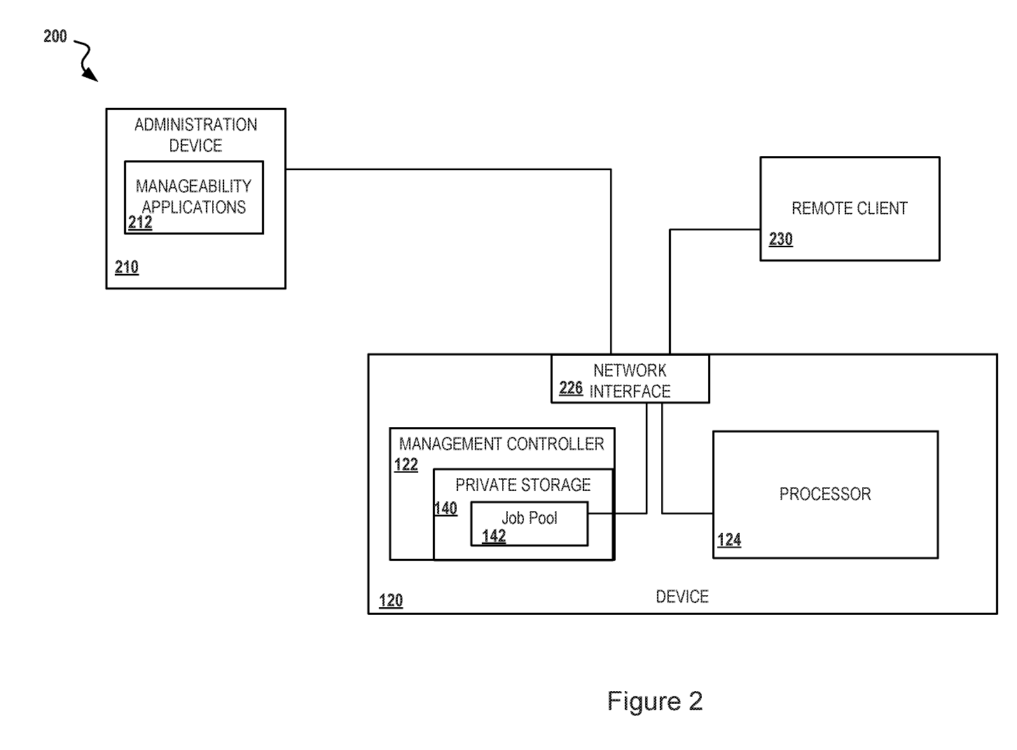

FIG. 2 illustrates an example system 200 including the example device 120 of FIG. 1 for securely queuing and processing a job in the device 120. In addition to the device 120, the system 200 includes an administration device 210 and at least one remote client 230. The administration device 210 includes a set of manageability applications 212. The manageability applications 212 may include software, firmware, hardware, or some combination thereof, that provides management tools that may be used by administrators of the system 200 to provision, control, or manage various components, such as the device 120 and various interconnect devices (not shown), as well as other components of the system 200. The administration device 210 may be communicatively coupled via a network or a direct connection to the device 120, which may be a rack-mount server, for example.

The remote client 230 may be any of a variety of computing devices that can communicate with the device 120. For example, the remote client 230 may be a desktop, laptop, tablet, smart phone or any other such computing device. The remote client 230 may communicate with the device 120 through a network, such as the Internet.

The example management controller 122 can be connected to a network using a communication port (e.g., the network interface 226) on the device 120, for example. The example management controller 122 is running and remains online regardless of the state of the processor 124. For example, whether the processor 124 is running or in an inactive mode (e.g., sleep mode), the management controller 122 remains available and accessible to external components, such as the administration device 210 and the remote client 230.

As noted above with reference to FIG. 1, the example management controller 122 is provided with an internal, private storage 140 forming a secure storage area. The private storage 140 is made secure, in part, by limiting access to the processor 124 and external components (e.g., the remote client 230 or the administration device 210) through a secure communication, which may comprise a secure protocol, a secure interface, or some combination thereof.

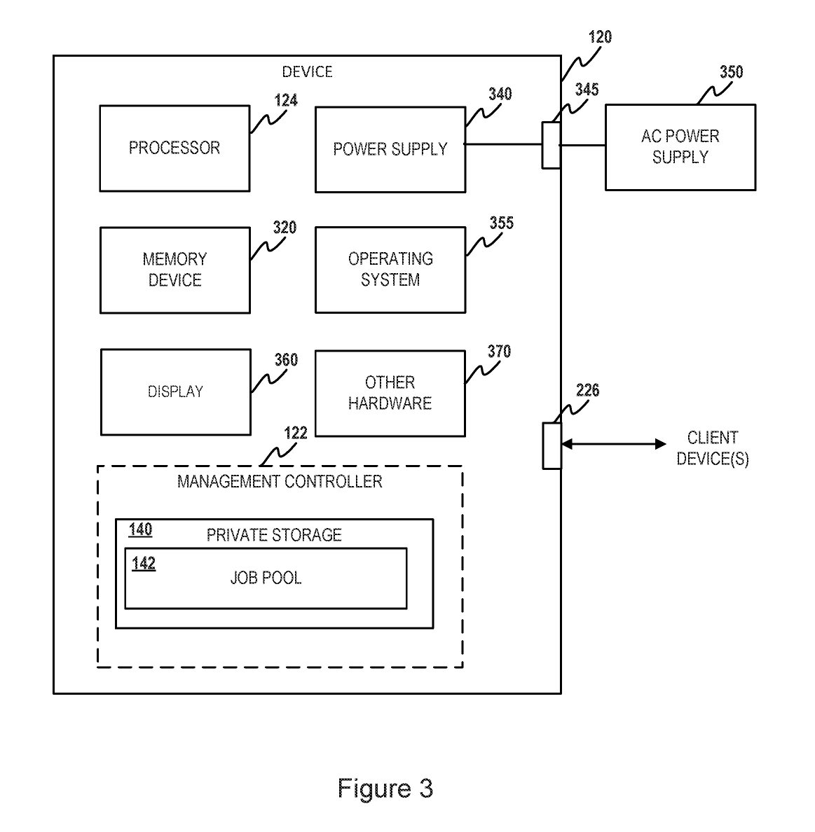

Referring now to FIG. 3, the example device 120 of FIG. 1 is illustrated in greater detail. The example device 120 may include embedded firmware and hardware components in order to perform various functions, some of which are described in detail below. The example device 120 may be any type of computing device, such as a portable computer or communication device, a standalone server computer, a blade server, etc. The example device 120 may include the main processor 124 (e.g., a central processing unit [CPU]), at least one memory device 320, and a power supply 340. The power supply 340 is coupled to an electrical interface 345, which is coupled to an external power supply such as an alternating current (AC) power supply 350.

The example device 120 may include an operating system 355 including, for example, an operating system driver component and a pre-boot Basic Input/Output System (BIOS) component stored in a read-only memory (ROM), and coupled to the main processor 124. In various examples, the main processor 124 may have a memory device 320, which may be non-transitory. In various examples, the memory device 320 may have one or more of ROM, programmable flash memory or erasable programmable ROM (EPROM). In various examples, the memory device 320 may be integrally formed with the main processor 124 or may be an external memory device. The memory device 320 may include program code that may be executed by the main processor 124.

The example device 120 may include a display 360 to provide visual information to a network administrator. The example device 120 also includes a network interface 226, and may include other hardware 370 known to those in the art. The network interface 226 is coupled to the network management fabric to allow communication between the example device 120 and other components, such as the administration device 210 or the remote client 230 shown in FIG. 2. In various examples, the example device 120 may also include a security module (not shown) to perform encryption, authentication and certificate verification operations to authenticate external devices, such as the administration device 210 and the remote client 230.

The private storage 140 may be made secure, in part, by allowing access to the processor 124 and external components (e.g., the remote client 230 or the administration device 210) only through a secure protocol, a secure interface, or some combination thereof. For example, in the example of FIG. 2, the processor 124, the remote client 230 and the administration device 210 may communicate with the private storage 140 only through the network interface 226. In various examples, the network interface 226 is a Representational State Transfer (REST) application program interface (API). REST follows certain constraints related to commands which may be transmitted therethrough. Further, communication to and from the private storage 140 may be encrypted and use a secure protocol, such as Hypertext Transfer Protocol Secure (HTTPS).

Using HTTPS REST, the private storage 140 may be accessed using a limited, pre-determined set of commands. For example, in one example, the processor 124, the remote client 230 and the administration device 210 may use the following HTTPS REST commands:

(1) GET/rest/v1/ip: This command may be used by an external component (e.g., the remote client 230 and the administration device 210) to obtain the status of the processor 124. For example, the remote client 230 or the administration device 210 may determine that the processor 124 is either running or in an inactive mode (e.g., sleep mode).

(2) POST/rest/v1/ip: This command may be used by an external component (e.g., the remote client 230 and the administration device 210) to set the processor 124 to a particular state. For example, the remote client 230 or the administration device 210 may start or reboot the system.

(3) POST/rest/v1/ip/job: This command may be used by an external component (e.g., the remote client 230 and the administration device 210) to add a job to the job pool 142 in the private storage 140.

(4) GET/rest/v1/ip/job: This command may be used by an external component (e.g., the remote client 230 and the administration device 210) or the processor 124 to obtain a list of all jobs in the job pool 142. This command may also return the status of each job in the job pool 142.

(5) GET/rest/v1/ip/job?id=n: This command may be used by the processor 124 to obtain contents of a particular job (e.g., job n) from the job pool 142 for processing.

(6) PATCH/rest/v1/ip/job?id=n: This command may be used by the processor 124 to update the status of a particular job. For example, once the contents of the job have been retrieved from the job pool 142 by the processor 124, the status of the job may be updated to “RUNNING”. Similarly, when the job is completed, the status of the job may be updated to “DONE”.

(7) DELETE/rest/v1/ip/job?id=n: This command may be used by an external component (e.g., the remote client 230 and the administration device 210) to remove a particular job from the job pool 142. For example, once a job is completed and returned to the external component, the external component may delete the job from the job pool 142.

Referring now to FIG. 4, the queuing and processing of a set of jobs from the job pool 142 in the example device 120 of FIG. 3 is schematically illustrated. As illustrated in FIG. 4, the job pool 142 may receive a set of incoming jobs, as indicated by the arrow 410. The set of incoming jobs may be received from an external component, such as the remote client 230 and the administration device 210. In this regard, the external component may use the HTTPS REST command (3) described above. For example, the external component may use the POST/rest/v1/ip/job command to post a job to the pool. The job may be added to the job pool 142 for processing.

The external components may poll the job pool to obtain status of a set of jobs in the job pool 142, as indicated by the arrow 420 in FIG. 4. In this regard, an external component may use the HTTPS REST commands (4) or (5) described above. For example, the external component may use the GET/rest/v1/ip/job command to obtain a list and status of jobs in the job pool 142. Further, the external component may use the GET/rest/v1/ip/job?id=n to obtain results of a particular command.

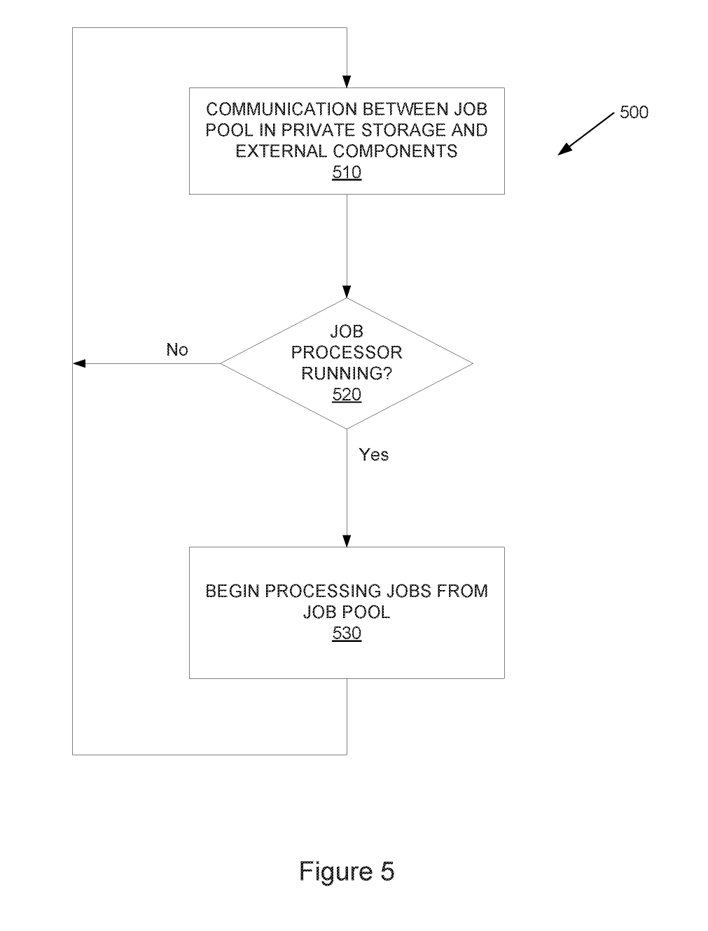

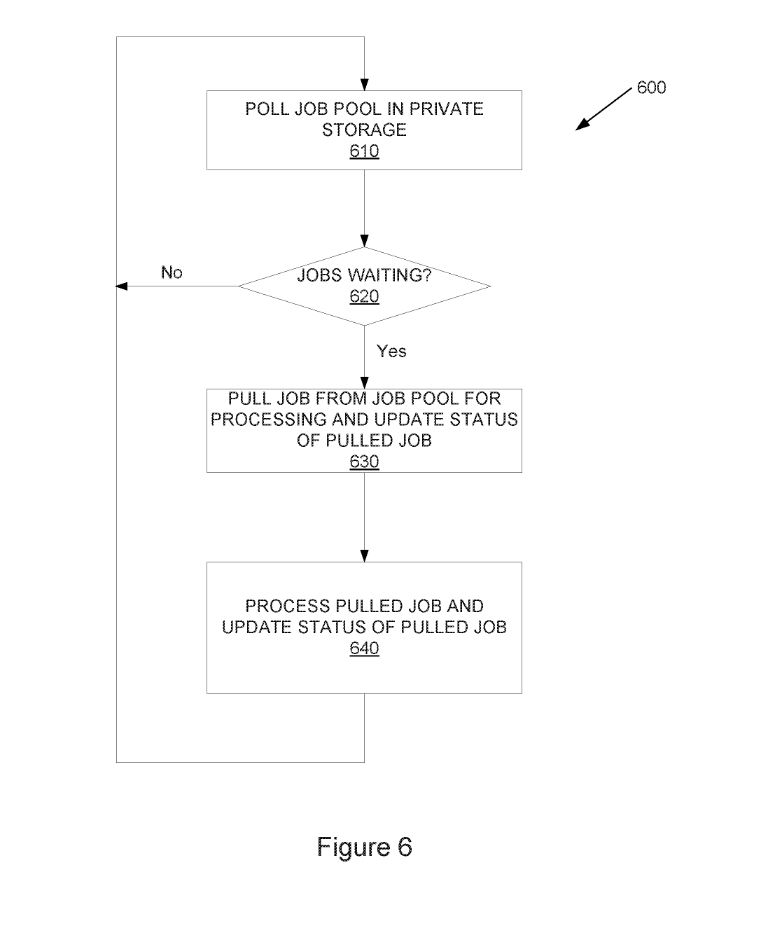

For processing of a set of jobs in the job pool, when the processor 124 is running, the processor 124 may communicate with the job pool 142 to obtain a set of jobs for processing, as indicated by the arrow 430 in FIG. 4. An example of the processing of a set of jobs in the job pool 142 by the processor 124 is described below with reference to FIGS. 5 and 6.

As noted above, the example embedded management controller 122 is running and remains online regardless of the state of the processor 124. Thus, whether the processor 124 is running or in an inactive mode (e.g., sleep mode), the management controller 122 remains available and accessible to external components. Accordingly, the communication between the job pool 142 and the external components, as indicated by the arrows 410 and 420, may occur when the processor 124 is running or in an inactive mode.

Referring to FIG. 5, an example flow diagram for an example process 500 for securely queuing and processing of a set of jobs is illustrated. At block 510, the job pool 142 in the private storage 140 communicates with various external components, such as remote clients 230. As described above, this communication may occur whether or not the job processor (e.g., the processor 124) is running or in an inactive mode. This communication is illustrated in the example of FIG. 4 by the arrows 410 and 420. As noted above, communication between the external components and the job pool 142 in the private storage 140 may include HTTPS REST commands from the external components, including the POST/rest/v1/ip/job command, the GET/rest/v1/ip/job command and the GET/rest/v1/ip/job?id=n command.

At block 520, a determination is made as to whether the job processor is running. If the processor 124 is not running, the process returns to block 510, and communication between the job pool and the external components can continue.

If the determination is made at block 520 that the processor 124 has started, the process proceeds to block 530, and the processor 124 may begin processing a set of jobs from the job pool 142, similar to the communication indicated by the arrow 430 in FIG. 4. As noted above, the communication between the external components and the job pool 142 may continue whether the server processor is running or in an inactive mode.

Referring now to FIG. 6, a flow chart illustrates an example process 600 for processing a set of jobs from the example job pool 142 by, for example, the processor 124. While the processor 124 is running, the server processor 124 polls the job pool 142 in the private storage 140 of the example embedded management controller 122 (block 510). In this regard, the processor may use the HTTPS REST command GET/rest/v1/ip/job to obtain a list of jobs and an associated status. At block 620, the processor 124 determines whether any jobs are waiting to be processed. The determination may be made based on the results of the GET/rest/v1/ip/job command at block 510. If no jobs are waiting to be processed, the process returns to block 510 and continues to poll the job pool 142.

If the processor 124 determines, at block 620, that there are a set of jobs awaiting processing, the processor 124 pulls a job from the job pool 142 for processing (block 630). In this regard, the server process may use the HTTPS REST GET/rest/v1/ip/job?id=n command to obtain the contents of the pulled job. Further, the processor 124 may use the HTTPS REST PATCH/rest/v1/ip/job?id=n command to update the status of the pulled job in the job pool 142. For example, the status of the job may be changed to “RUNNING”.

The processor 124 may then perform the necessary operations to complete processing of the pulled job (block 640). In this regard, the processor 124 may use software installed on the device 120 to execute instructions necessary to process the job. Further, the processor 124 may use the HTTPS REST PATCH/rest/v1/ip/job?id=n command to update the status of the pulled job in the job pool 142 to, for example, “DONE”. Upon completion of processing of the pulled job, the process 600 may return to blocks 610 and 620 and determine whether an additional set of jobs in the job pool 142 are awaiting processing.

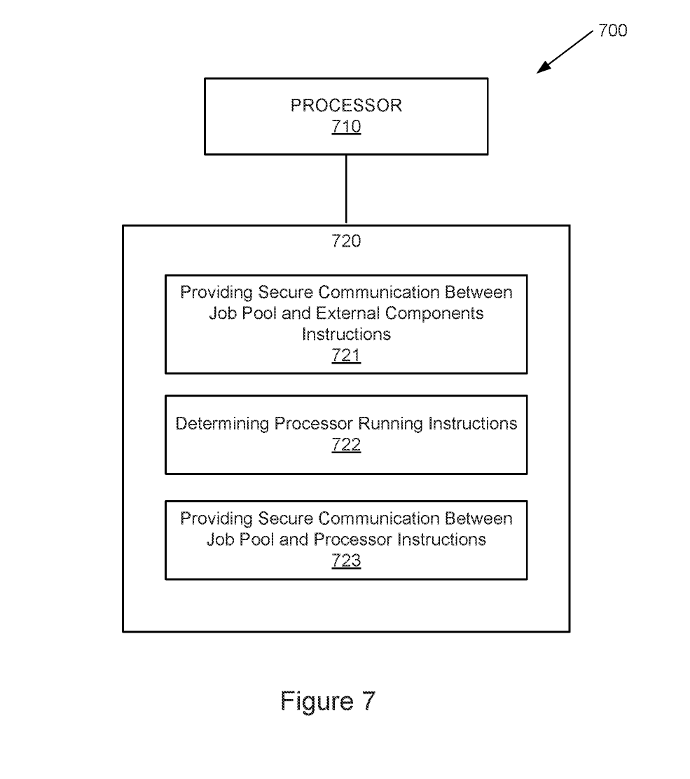

FIG. 7 illustrates a block diagram of an example system with a computer-readable storage medium including example instructions executable by a processor to provide secure queuing and processing of a job pool. The system 700 includes a processor 710 and a computer-readable storage medium 720. The computer-readable storage medium 720 includes example instructions 721-723 executable by the processor 710 to perform various functionalities described herein.

The example instructions includes providing secure communication between the job pool and external components instructions 721. The instructions 721 may cause the processor 710 to enable communication between the job pool 142 in the private storage 140, as described above, with various external components, such as remote clients 230. As described above, this communication may occur whether or not the job processor (e.g., the processor 124) is running or in an inactive mode.

The example determining processor running instructions 722 may cause the processor 710 to determine if the job processor is running. Further, example providing secure communication between job pool and processor instructions 723 may cause the processor 710 to provide secure communication between the job pool and the job processor. For example, as noted above, the processor 124 may begin processing a set of jobs from the job pool 142.

The set of jobs queued and processed through the example job pool 142 described above may include any of a variety of jobs which cannot be processed by the embedded management controller 122. For example, the job pool 142 may include a job from the remote client 230 which utilize functionality provided on the device 120, including executing software available on the server or fetch information provided on the server. Further, the job pool 142 may be used to perform certain specialized functions for a set of jobs received from the administration device 210. For example, this set of jobs may include operating system deployment or upgrade or configuration of hardware that is not visible to the embedded management controller 122. For example, the job pool 142 may receive a set of jobs from the administration device 210 to install or configure a printer that is in communication with the device 120. In this regard, the example systems and methods described above may provide secure job queuing which can receive a set of jobs even when the job processor (e.g., the processor 124) is not running (e.g., in an inactive mode).

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a processor; and
a secure storage area having accessibility limited to a secure communication, wherein the secure storage area stores a job pool with at least one job to be processed, wherein the processor is to process the at least one job from the job pool when the processor is running, and wherein the secure storage area is a private storage of a management controller of the device.

2. The device of claim 1, wherein the management controller is to run when the processor is running and when the processor is not running.

3. The device of claim 1, wherein access to the secure storage area by the processor and a remote client is limited to a secure communication.

4. The device of claim 3, wherein the secure storage area is to receive a job in the job pool from remote clients when the processor is running and when the processor is not running.

5. The device of claim 1, wherein the secure storage area has accessibility limited through a secure protocol.

6. The device of claim 1, wherein the secure storage area has accessibility limited to using a pre-determined set of commands, the pre-determined set of commands including commands to:
obtain a status of at least one job in the job pool;
obtain a result of a job in the job pool;
add at least one job to the job pool;
update a status of at least one job in the job pool; and
remove at least one job from the job pool.

7. A method, comprising:
securely communicating, by a job pool in a secure storage area, with at least one remote client, the job pool including at least one job to be processed;
determining when a processor to process the at least one job in the job pool has started running; and
securely communicating, by the job pool, with the processor to process the at least one job, wherein the secure storage area is a private storage of a management controller of a server device.

8. The method of claim 7, wherein the job pool in the secure storage area is to receive a job from the at least one remote client when the processor is running and when the processor is not running.

9. The method of claim 7, wherein the secure storage area has accessibility limited through a secure protocol and through a pre-determined set of commands.

10. The method of claim 9, wherein the pre-determined set of commands includes commands to:
obtain a status of at least one job in the job pool;
obtain result of a job in the job pool;
add at least one job to the job pool;
update a status of at least one job in the job pool; and
remove at least one job from the job pool.

11. A non-transitory computer-readable storage medium encoded with instructions executable by a processor of a computing system, the computer-readable storage medium comprising instructions to:
provide secure communication between a job pool in a secure storage area of a management controller and at least one remote client, the job pool including at least one job to be processed;
determine when a processor to process the at least one job in the job pool has started running; and
provide secure communication between the job pool and the processor to process the at least one job.

12. The non-transitory computer-readable storage medium of claim 11, wherein the job pool in the secure storage area is to receive a job from the at least one remote client when the processor is running and when the processor is not running.

13. The non-transitory computer-readable storage medium of claim 11, wherein the secure storage area has accessibility limited through a secure protocol.

14. The non-transitory computer-readable storage medium of claim 13, wherein the secure storage area has accessibility limited through a pre-determined set of commands.

15. The non-transitory computer-readable storage medium of claim 14, wherein the pre-determined set of commands includes commands to:
obtain a status of at least one job in the job pool;
obtain result of a job in the job pool;
add at least one job to the job pool;
update a status of at least one job in the job pool; and
remove at least one job from the job pool.
